(19) United States
(12) Patent Application Publication
(10) Pub. No.: US 2015/0339763 A1
(43) Pub. Date: Nov. 26, 2015

(54) METHOD AND SYSTEM FOR DISPLAY PRODUCT INFORMATION

(71) Applicant: Molex Incorporated, Lisle, IL (US)

(72) Inventors: Jason STIPANUK, Clarendon Hills, IL (US); Meni BOUGIOTOPOULOS, La Grange Park, IL (US)

(73) Assignee: Molex Incorporated, Lisle, IL (US)

(21) Appl. No.: 14/720,046

(22) Filed: May 22, 2015

Related U.S. Application Data
(60) Provisional application No. 62/001,735, filed on May 22, 2014.

(51) Int. Cl. G06Q 30/06

(52) U.S. Cl. CPC G06Q 30/0643; G06Q 30/0623

(57) ABSTRACT

A method of displaying information in an easy to understand and use method is disclosed. Groups of product can be displayed on a screen of a mobile device. Selection of a group allows a family of products within the group to be displayed in a perspective view. Selection of a family allows for additional details regarding the family to be displayed. The active family, prior to selection, can be highlighted and can be changed by swiping the screen with a finger.

### RELATED APPLICATIONS

This application claims priority to U.S. Provisional Application No. 62/001,735, filed May 22, 2014, which is incorporated herein by reference in its entirety.

### FIELD OF THE INVENTION

The present invention relates to the field of providing information, more specifically to the field of displaying information regarding a product family.

### DESCRIPTION OF RELATED ART

Databases are commonly used to store information about large families of products. Often these databases are provided in servers that are accessible via the Internet. While the use of such a database is helpful, one issue that exists is when such a database is being accessed from a mobile device (such as a smart phone). Mobile devices tend to have fluctuating access to the Internet. This creates a challenge for an individual desiring to provide information regarding the database to a potential user.

Another problem that exists is that many applications that provide access to information stored in a database are not well suited to an end users user interface. A web-based application, for example, might be configured for a user that has a mouse and keyboard. Thus, providing an application that can be compatible for a number of physically different interfaces is difficult. Consequentially, certain individuals would appreciate further improvements to method of accessing information regarding a database of products.

### BRIEF SUMMARY

An application is provided that can be stored on a mobile device. The application includes a number of details regarding product families. Each product family can be displayed in a perspective visual manner so as to allow for ease of selection of a particular product. Certain information that is expected to be valuable to a customer is stored locally while additional information regarding features that are less likely to be of interest can be stored remotely.

### BRIEF DESCRIPTION OF THE DRAWINGS

The present invention is illustrated by way of example and not limited in the accompanying figures in which like reference numerals indicate similar elements and in which:

FIG. 1 illustrates a flow chart of an exemplary method of displaying information regarding a group of product.

FIG. 2 illustrates an exemplary embodiment of a method of displaying a group of products.

FIG. 3 illustrates an exemplary embodiment of a method of displaying a family of products.

FIG. 4 illustrates an exemplary embodiment of a method of displaying a set of models.

FIG. 5 illustrates an exemplary embodiment of a method of displaying information about a model.

FIG. 6 illustrates an exemplary embodiment of a method of displaying additional information about a model.

FIG. 7 illustrates a schematic representation of exemplary embodiment of a system configured to provide information to a user.

### DETAILED DESCRIPTION

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

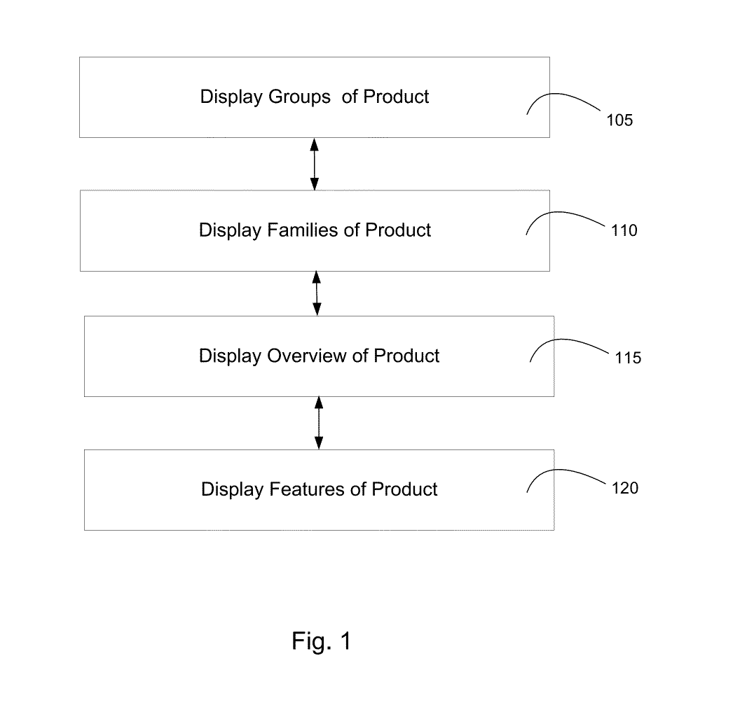

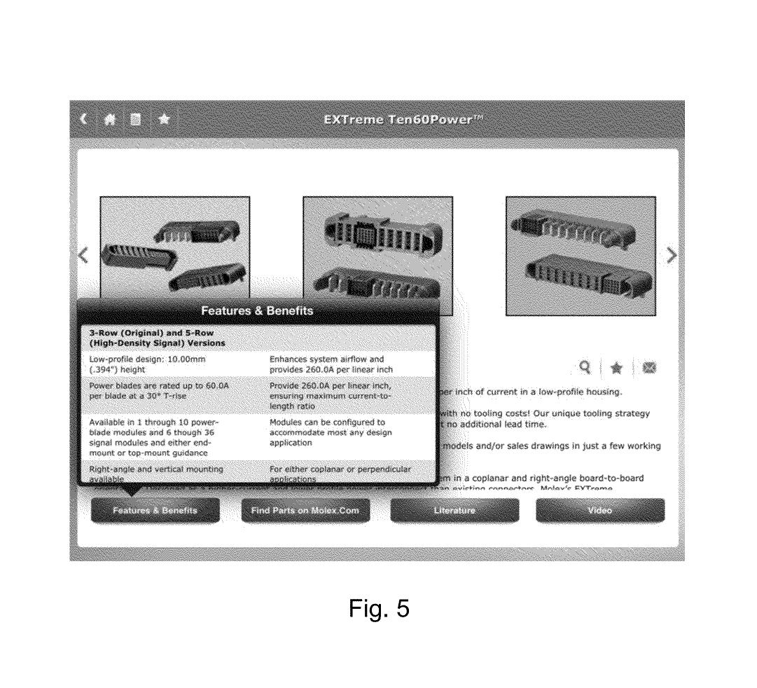

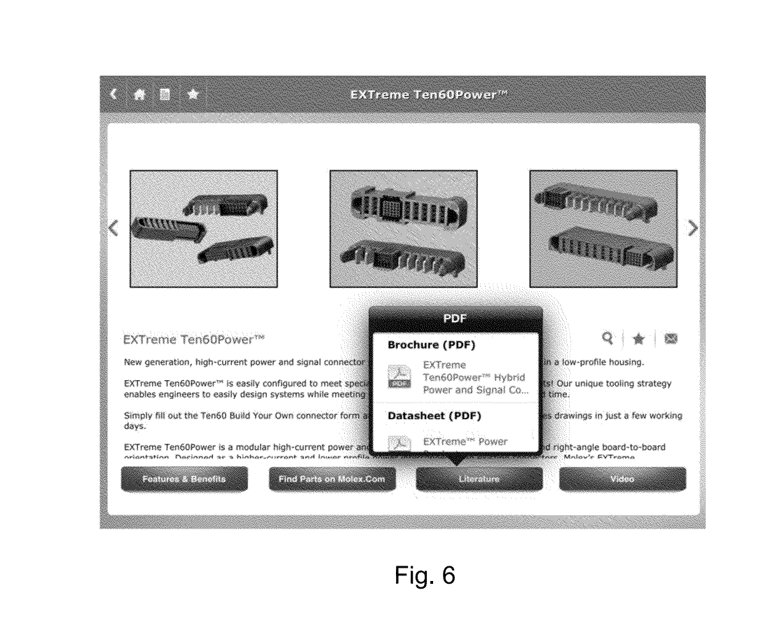

FIGS. 1-6 illustrate embodiments of a method of disclosing information regarding products. One issue that has been determined problematic in prior solutions is the manner in which the information is displayed. This is because existing method of displaying information is often poorly suited to be used in a variety of interfaces. For example, a hierarchical folder-based system tends to be overly complicated when dealing with large numbers of products. In part, this is because there often is no easy way to see a relationship between difference products on one screen, particularly if the screen is relatively small (e.g., something suitable for a tablet or smartphone). Therefore, while having a larger display allows for a view of a large number of products at once and thus allows for ease of use when in a laptop or desktop, the reduced screen size of a portable device makes such a method of providing information undesirable.

The depicted method of providing additional information allows for ease of use with a touch-screen display. Prior UIs tend to be modifications of standard flat displays that, while functional, don't take advantage of the natural inclinations of a user interacting with a touch screen.

To address such interface issues, FIG. 1 illustrates a method of providing the information to a user. In step 105 a group of products are depicted, this group of products can be changed to a different group of products if desired. In an embodiment, the group of products can be changed by swiping the screen left or right. The active group is indicated as being active, typically with some sort of visual indicia (such as, without limitation, highlighting). In response to a selection of the active group, in step 110 a perspective depiction of different families within the group are depicted. A primary location is provided on the display and the family that is positioned in the primary location is highlighted and shifted with respect to the other families displayed and additional information about that family is provided. Different families can be positioned in the primary location in response to a user moving the perspective display by dragging the display with a finger. In response to selection of a particular family, an overview is provided in step 115 regarding a family. The level of detail provided can be varied depending on the type of product being depicted but preferably enough information is disclosed to allow the user to appreciate primary benefits on of the product. In step 120, further information regarding the product can be provided in response to an appropriate selection. The various levels can be revisited, thus the method allows a user to readily view more or less information, as well as switch between groups or families of products.

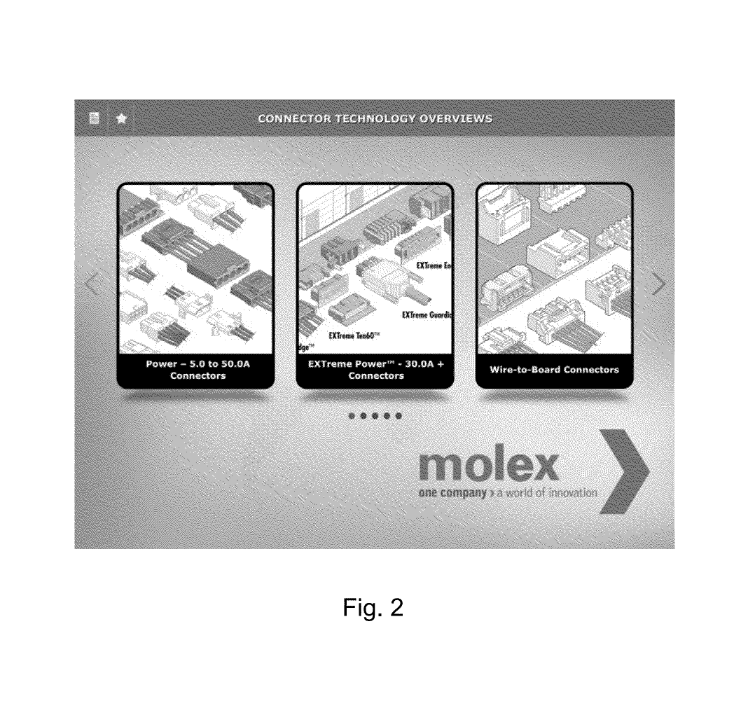

FIGS. 2-6 illustrate embodiment of screens that can be used to carry out the method of FIG. 1. As depicted, several groups of products are depicted. Groups of products can be based on a desired category (such as function, performance, weight, etc.). In the depicted embodiment, connectors can be grouped based on functionality (power, input/output, consumer, backplane, etc.). To allow for ease of use of the depicted information, the three groups of product that are depicted can be switched to different set of three groups of products. The image associated with each group provides additional information regarding families of products that are within the group.

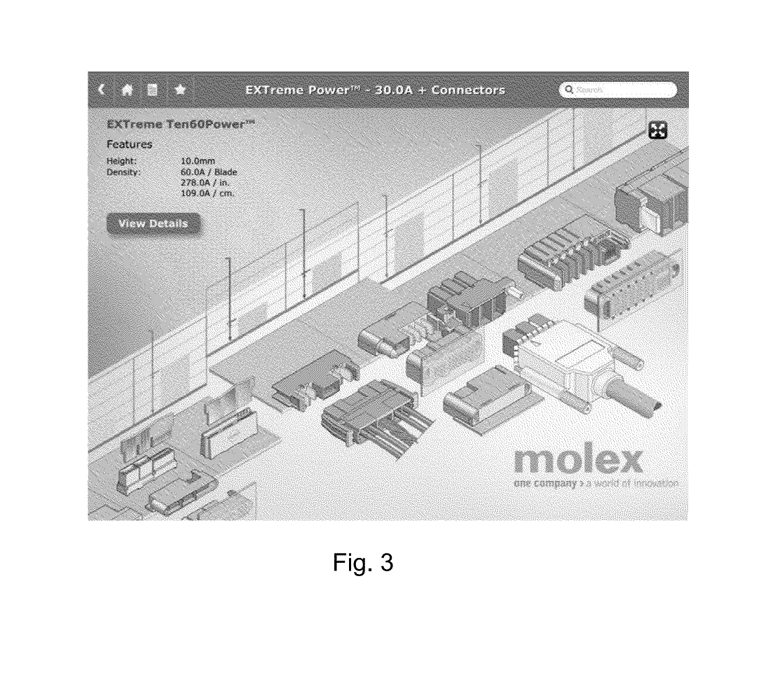

Upon selection of a group, a perspective illustration of possible choices is depicted, such as is depicted in FIG. 3. As depicted, the members of the group are connectors. The perspective view is important to the display as it allows for a visual comparison to similar connectors even on a small display and, at least on larger displays, can allow for most or all of a family to be depicted at once. This can, for example, show the relative size of the members of the group.

On a touch-based display, a user can slide the perspective row of connectors back and forth, bringing the desired connector to the primary location (which as depicted, is in the middle but could be positioned on a side if so desired). The primary location preferably shifts the product slightly out of the angled row and can also modify the color of the product so as to help the user to appreciate which product is in the primary location. In an embodiment the product in the primary location can be in color and the other products can be in some other color scheme such as gray scale or monocromatic. An area is provided that includes information about whichever connector is in the primary location. In an embodiment, the connectors in the family can be arranged from small to large, low performance to high performance, low cost to high cost or some other suitable arrangement.

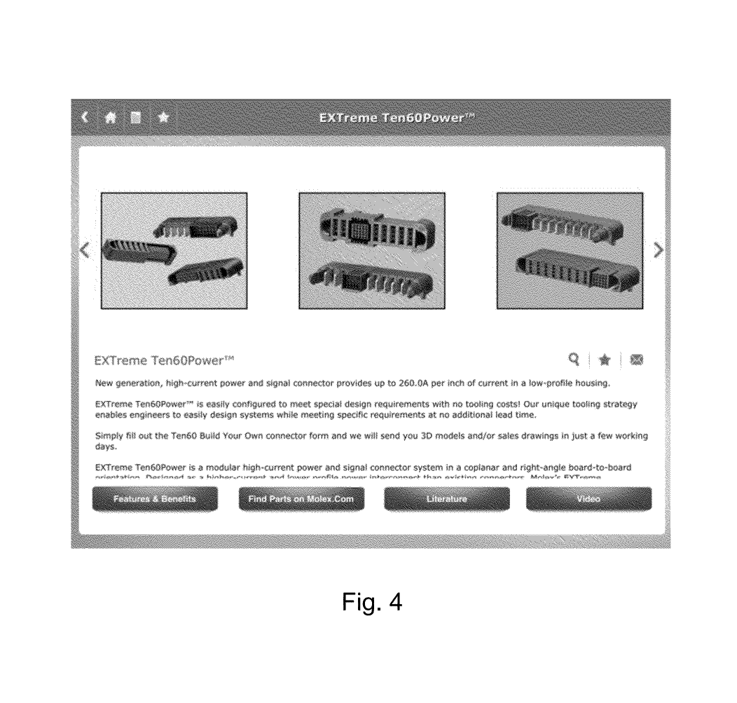

Once a particular product is selected, a screen that provides additional information regarding various options is displayed (as depicted in FIG. 4). A user can obtain additional information by selecting the appropriate option. In addition, the mobile device can be used to query external databases so as to provide additional information. Of course, the ability to do so requires that the mobile device have access to a network that can access the remote server. If a network is not available at that time a user can save favorites and readily obtain the networked information at a later time once a suitable network connection become available. Thus, the depicted methods are well suited to enhancing productivity while providing varying levels of information depending on the user's connection to a suitable network.

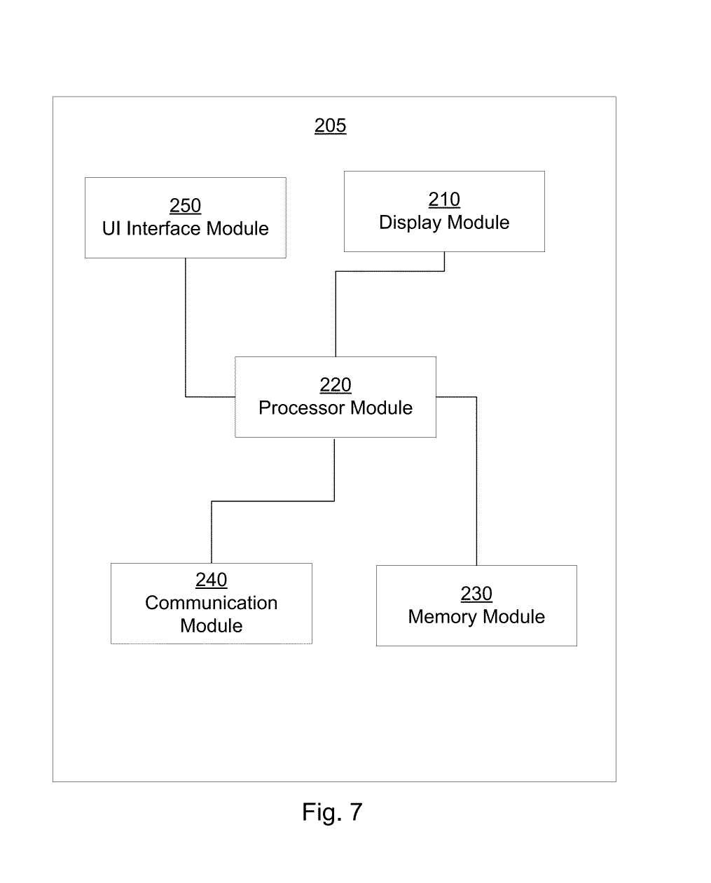

FIG. 7 illustrates an exemplary mobile device 205 suitable for displaying information about a group of products. The mobile device includes a processor module 220 is configured to process user input received from an UI interface module 250, obtain information from a memory module 230 in response to queries and input, display the information on a display module 210 (which could be a conventional display) and use the communication module 240, if it is activated, to obtain additional information. Naturally, the mobile device 205 will include other conventional modules, such as a power source, speakers and the like (not shown for purposes of brevity).

In an embodiment, a set of connector data is provided in a desired data structure, typically a database arrangement, and a set of that connector data made available to the processor module 220. In an embodiment this can be by downloading the set of connector data onto the memory module 230. The set of connector data can then be used to provide the desired functionality as discussed above.

As can be appreciated, the depicted display structure is not limited to use with connectors but instead could be used for any type of component or system where there are a number of product groups and each group includes a plurality of family members. Thus, unless otherwise noted, this disclosure is not limited to connectors.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

We claim:

1. A method of providing information with a mobile device, comprising:
providing to a mobile device a set of connector data, the connector data including structural shapes of a plurality of different connector types;
displaying the plurality of different types of connectors in groups on a screen of the mobile device so that at least one of the structure shapes of the plurality of different types of connectors within each group is visible for each group displayed on the screen;
providing a first indicator of an active connector group on the screen;
receiving a selection of the active connector group;
in response to the selection, displaying a perspective view a plurality of connectors families that fall within the selected connector group, wherein the displaying depicts the structural shapes of a portion of the plurality of connector families, the displaying including a second indicator of the active connector family;
receiving a selection of the active connector family; and
in response to the selection of the active connector family, displaying additional information about the active connector family.

2. The method of claim 1, wherein the providing of an indicator includes depicting a primary location on the screen with highlighting.

3. The method of claim 2, wherein the receiving a selection of the active connector group includes receiving a finger swipe for a first side to a second side of the screen to alter the active connector group and receiving a finger press in the primary location.

4. The method of claim 1, wherein the providing the second indicator includes highlighting the active connector family.

5. The method of claim 5, wherein the displaying the perspective view arranges the families of connectors in an angled row and the providing the second indicator shifts the active family of connectors partially out of the row.

6. The method of claim 6, wherein providing the second indicator changes the color of the active family of connectors.

7. The method of claim 1, wherein receiving the selection of the active connector family includes the steps of receiving a finger swipe on the screen to position a desired connector family in a primary location and receiving a finger press to indicate a selection of the active connector family.
